(19) United States
(12) Patent Application Publication
(10) Pub. No.: US 2013/0082118 A1
(43) Pub. Date: Apr. 4, 2013

(54) Portable Pressure Washer System

(71) Applicant: Christine Stepflug, Caledonia, MN (US)

(72) Inventor: Christine Stepflug, Caledonia, MN (US)

(21) Appl. No.: 13/249,891

(22) Filed: Sep. 30, 2011

(51) Int. Cl. B05B 9/08

(52) U.S. Cl. 239/152

(57) ABSTRACT

A portable pressure washer comprising: a tank, where the tank stores water used in conjunction with the pressure washer; a hose, where the hose is connected the tank at a connection end provides the transfer of pressurized water from the tank; a nozzle, where the nozzle attaches to a emission end of the hose; and a convertible power supply, where the power supply provides at least two forms of a power source. The power supply may include a cord and a connector. In one particular embodiment, the connector is an AC/DC converter. The power supply may also include a battery pack.

### BACKGROUND OF THE INVENTION

1. Field of Invention

The present invention relates to a pressure washer system to provide a portable system for a high-pressure washer.

2. Description of Related Art

Pressure washers are commonly used to remove stains and/or finish and are typically used in a outdoor environment. Pressure washers may be electrically powered or gas powered and are presently used to transmit high-pressure water in a stream for contact onto a surface. The water is pressurized and then dispersed through a gun, hose or other emissions device during use. Various types of pressure washers are used in portable means and normally require electrical power or even gas power to power the pressure washer. Presently there are few choices with regards to the power source of a pressure washer. Many pressure washers run off generators or connect to an AC connection in order to supply the energy to run the compressor and other functioning components of the pressure washer. Therefore it would be advantageous to have a pressure washer that is portable and has optional features with respect to power source to provide adequate power for the functioning of the pressure washer.

### SUMMARY OF THE INVENTION

The present invention relates to a portable pressure washer comprising: a tank, where the tank stores water used in conjunction with the pressure washer; a hose, where the hose is connected the tank at a connection end provides the transfer of pressurized water from the tank; a nozzle, where the nozzle attaches to a emission end of the hose; and a convertible power supply, where the power supply provides at least two forms of a power source. The power supply may include a cord and a connector. In one particular embodiment, the connector is an AC/DC converter. The power supply may also include a battery pack.

### BRIEF DESCRIPTION OF DRAWINGS

FIG. 1 provides a prospective view of a pressure washer in accordance with the present invention.

### DETAILED DESCRIPTION

The present invention relates to a pressure washer that is portable and convenient to use in various applications. The pressure washer according to present invention includes a durable water tub with an adjustable nozzle spray gun with a motor rated at 12 volts of power. The pressure washer according to present invention is portable and may advantageously be plugged into a DC converter power outlet or function with a battery pack that is provided with the pressure washer. The pressure washer provides a connection for a DC converter that is typically found within a motor vehicle. Further this connection may be used to charge the battery pack that is provided with the pressure washer according to the present invention. The portability of the pressure washer allows the user to conveniently store and retrieve the washer as needed and further conveniently provide power to the washer through the use of a DC adapter.

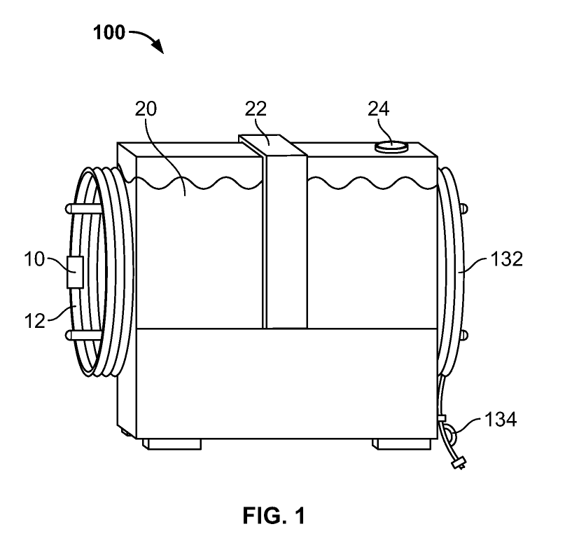

With reference to FIG. 1, a portable pressure washer 100 is depicted in accordance with the present invention. The pressure washer 100 according to present invention includes a tank 20 that stores sufficient water for use with the pressure washer according to present invention. Although not shown the pressure washer also includes compressors and other functional components in order to adequately supply high pressure water through a nozzle 134 depicted in FIG. 1. The nozzle 134 is connected to a hose 132 that may be extended and used in conjunction with the nozzle 134 while emitting high-pressure water through the nozzle. The tank 20 further includes a fuel cap 24 for the insertion of water into the tank for use with the pressure washer 100. The portability of the pressure washer 100 is provided through the use of a pull strap 22 that extends across the body of the tank 20. This allows the user to easily transport and maneuver the pressure washer 100 as needed.

The unique feature of the present invention relates to the power source capabilities of the pressure washer 100. A connector 10 extending from power cord 12 is provided at one end of the pressure washer 100. The connector 10 functions as an AC/DC converter that connects to a DC outlet in a vehicle. This connector 10 therefore allows the user to adapt and utilize power directly from a motor vehicle through a cigarette lighter type outlet. Further within the pressure washer 100 is a battery pack, not shown, that maybe provide adequate power as an alternative to the connection provided by the power cord 12. Because the pressure washer 100 is portable it may be maneuvered in various positions and utilized without a direct connection of the power cord 12. Once the power cord 12 is connected, the power transmitted through the power cord helps to charge the battery pack and provide power for use with the pressure washer 100. The pressure washer according to present invention utilizes a rubber hose for the hose 132 and provides an efficient alternative to gas powered equipment, which is normally heavier and more cumbersome to maneuver.

What is claimed is:

1. A portable pressure washer comprising:
a. a tank, where the tank stores water used in conjunction with the pressure washer;
b. a hose, where the hose is connected the tank at a connection end provides the transfer of pressurized water from the tank;
c. a nozzle, where the nozzle attaches to a emission end of the hose; and
d. a convertible power supply, where the power supply provides at least two forms of a power source.

2. The portable pressure washer according to claim 1, where power supply includes a cord and a connector.

3. The portable pressure washer according to claim 2, where the connector is an AC/DC converter.

4. The portable pressure washer according to claim 1, where the power supply includes a battery pack.
